(19) United States
(12) Patent Application Publication
(10) Pub. No.: US 2017/0345056 A1
(43) Pub. Date: Nov. 30, 2017

(54) ADVERTISEMENT DATA METRIC DETERMINATION WITHIN MOBILE APPLICATIONS

(71) Applicant: App Annie Inc., San Francisco, CA (US)

(72) Inventors: Yu Chen, Beijing (CN); Andrey Kazakov, Foster City, CA (US); Maxim Gannutin, Foster City, CA (US); Vitali Kotsik, St. Petersburg (RU); Swetha Sudarshan, Fremont, CA (US)

(21) Appl. No.: 15/607,082

(22) Filed: May 26, 2017

Related U.S. Application Data
(60) Provisional application No. 62/342,826, filed on May 27, 2016.

(51) Int. Cl. G06Q 30/02

(52) U.S. Cl. CPC G06Q 30/0255; G06Q 30/0277; G06Q 30/0201; G06Q 30/0242

(57) ABSTRACT

An advertisement analysis system generates reports that include ad share or spend information within mobile applications. The system identifies a list of mobile applications to track and scans for a known software development kit (SDK) code within each application. If a known ad network SDK is found, the advertisement analysis system simulates the mobile application by plugging in the application having the known SDK within a test application. The test application sends network requests to the ad network to determine a publisher-id pattern of the ad network. The advertisement analysis system searches for the determined pattern within each mobile application and stores it as a key. The advertisement analysis system sends requests to the ad network using stored keys, and extracts ad information from the responses of the ad network. The advertisement analysis system aggregates the ad information and generates an ad report that includes the ad share/spend information.

### CROSS-REFERENCE TO RELATED APPLICATIONS

This application claims the benefit of U.S. Provisional Application No. 62/342,826, filed May 27, 2016, which is incorporated by reference in its entirety.

### BACKGROUND

This invention relates generally to the field of estimating advertisement share and spend, in particular to the estimating advertisement share and spend of a third party mobile application.

Mobile devices such as mobile phones and tablets typically have many mobile applications installed on them, and these mobile devices often execute more than one of these applications concurrently. A mobile application may host advertisements (ads), for various reasons, for example, for monetization from an ad network. An ad network aggregates ads from a variety of publishers and serves the ads to the third party mobile applications based on a variety of criteria specified by the published of the ad, and/or by matching the requirements of the consumer of the ad, i.e. the third party mobile application. The ad networks may have the ability to report ad impressions for an ad publisher, but the report may be limited to a subset of users that the ad network serves. A business, competitor, or any consumer may be interested in determining their spending on different types of advertisements across different publishers, or across the entire user base that was served their advertisement, or a market share of an ad within one or multiple third party mobile applications.

### SUMMARY

An advertisement analysis system generates reports that display ad share and/or spend of an advertisement within one or more mobile applications. The advertisement analysis system identifies a list of mobile applications on a client device to track. The programming code for each mobile application is inspected to determine if the mobile application includes a known software development kit (SDK) code or binary signature of the known SDK, the SDK may include software for communicating with an advertising network (ad network), for example, sending network requests to the ad network. Typically, advertising networks (ad networks) provide an application developer with embeddable SDKs to plug in to their application code, so that the mobile application may serve ads to their users. If a known ad network SDK is found, the advertisement analysis system simulates the mobile application by plugging in the known SDK within a test application. The test application is configured to send network requests to the ad network, and the ad network requests are inspected to determine a publisher identifier (“publisher-id pattern”) for the particular ad network SDK. Once a pattern is determined, the mobile application code is scanned to determine its publisher-id. The publisher-id can be used for requesting an ad from the ad network. For each mobile application on the list, a key (i.e., a publisher-id and its associated mobile application) is determined. The keys are stored in a database.

Based on the stored keys for each application, the advertisement analysis system sends requests to the ad network using the publisher-id of the actual mobile application. The ad networks process the request and generate a response that includes data that describes an ad. The advertisement analysis system extracts ad information from the response, aggregates the ad information received from each publisher, for each application, and generates an ad creative report. The advertisement analysis system calculates ad data metrics based on the obtained ad information across one or more mobile applications. For example, the number of impressions of an ad for an advertising network may be determined from the ad response. The ad data metrics may be used to calculate the percentage (%) share of an ad per network. The ad creative reports may include such calculated data metrics. The ad creative reports may also include a set of ad creatives corresponding to advertisements presented to users of client devices operating the mobile applications, an identifier for mobile application that displayed the advertisements, identifiers for the publishers of the advertisements, or other such related metrics. In one embodiment, the metrics may be adjusted to reflect an actual usage data estimated by the advertisement analysis system.

### BRIEF DESCRIPTION OF THE DRAWINGS

FIG. 1 is a block diagram illustrating a computing environment for an advertisement analysis system within one or more mobile applications, according to one embodiment.

FIG. 2 is a block diagram illustrating functional components of an advertisement analysis system according to one embodiment.

FIG. 3 is a flow diagram illustrating a method for generating an ad report according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

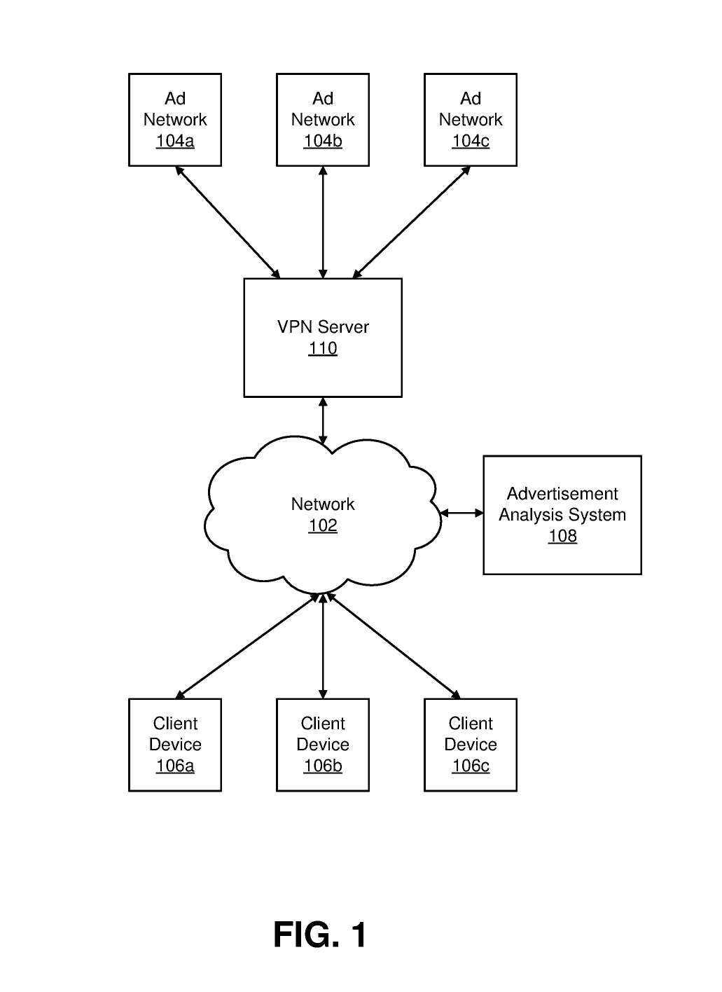

FIG. 1 is a block diagram illustrating a computing environment for an advertisement analysis system within one or more mobile applications, according to one embodiment. The computing environment shown by FIG. 1 comprises one or more client devices 106, a network 102, one or more mobile ad networks 104, a VPN server 110 and an advertisement analysis system 108. Alternate embodiments may include more, fewer, or different components from those illustrated in FIG. 1, and the functionality of each component may be divided between the components differently from the description below. Additionally, each component may perform their respective functionalities in response to a request from a human, or automatically without human intervention.

The client devices 106 are one or more computing devices capable of receiving user input as well as transmitting and/or receiving data via the network 102. In one embodiment, a client device 106 is a smartphone, a tablet or a conventional computer system, such as a desktop or laptop computer. Alternatively, a client device 106 may be a device having computer functionality that accesses a set of mobile applications. A client device 106 is configured to communicate via the network 102. In one embodiment, a client device 106 executes a mobile application allowing a user of the client device 106 to interact with the advertisement analysis system 108. For example, a client device 106 executes a browser application that may enable interaction between the client device 106 and advertisement analysis system 108 via the network 102. In another embodiment, a client device 106 interacts with the advertisement analysis system 108 through an application programming interface (API) running on a native operating system of the client device 106, such as IOS® or ANDROID™.

The client devices 106 are configured to communicate via the network 102, which may comprise any combination of local area and/or wide area networks, using both wired and/or wireless communication systems. In one embodiment, the network 102 uses standard communications technologies and/or protocols. For example, the network 102 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 102 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 102 may be represented using any suitable format, such as hypertext markup language (HTML) or extensible markup language (XML).

In another embodiment, the network 102 includes a VPN tunnel coupled to the VPN application on the client device 106. The VPN application monitors the network traffic via the network 102, determines a usage metric of the mobile applications executing on the client devices 106, and pushes the usage information to the VPN server 110. The advertisement analysis system 108 may retrieve the usage information from the VPN server 110. In some embodiments, all or some of the communication links of the network 102 may be encrypted using any suitable technique or techniques.

One or more mobile ad networks 104 may be coupled to the advertisement analysis system 108 via the network 102, or via the VPN server 110 or may be directly coupled to the ad network 104. An ad network 104 connects advertisers and/or publishers to mobile applications that want to host advertisements. The mobile applications may request an ad network 104 to serve an ad that is displayed to the user of the client device 106 via the mobile application. Typically, a client device 106 may send an ad request to an ad network 104 via the network 102. The advertisement analysis system 108 simulates a mobile application environment to determine which mobile application is served which ads from the ad networks 104. Example ad networks include Google AdSense, Facebook SDK, AdMobi, Yahoo and other such ad networks.

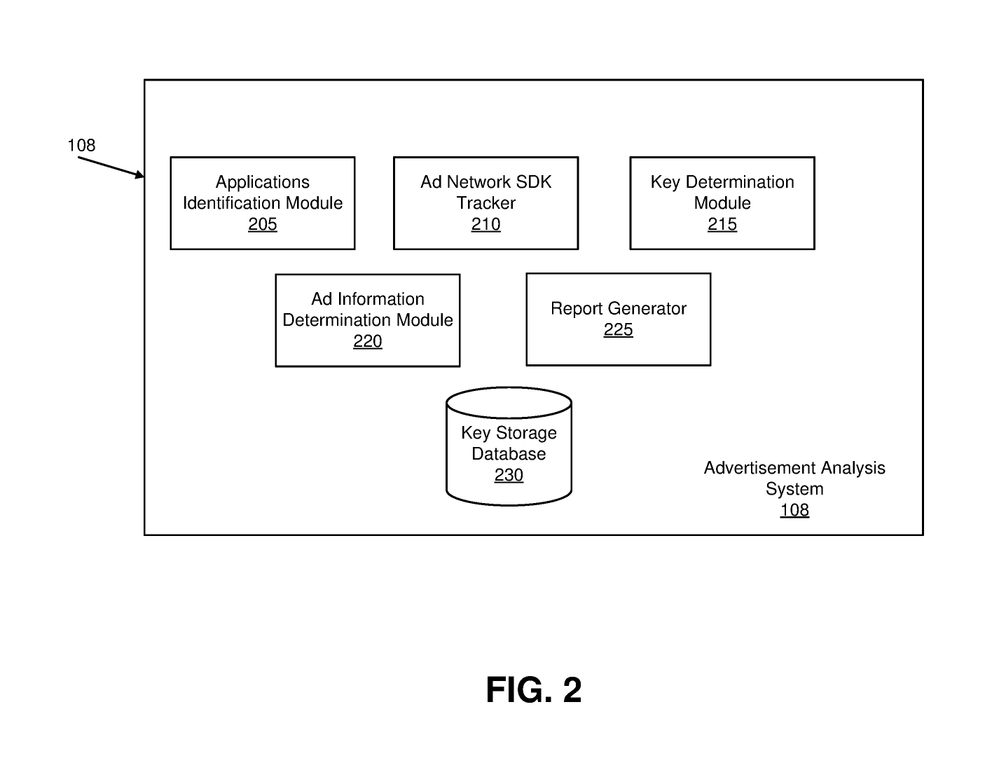

FIG. 2 is a block diagram illustrating functional components of an advertisement analysis system according to one embodiment. The advertisement analysis system includes an application identification module 205, an ad network SDK tracker 210, a key determination module 215, an ad information determination module 220, a report generator 225 and a key storage database 230 that can store and retrieve keys associated with actual mobile applications. Alternate embodiments may include more, fewer, or different components from those illustrated in FIG. 2, and the functionality of each component may be divided between the components differently from the description below. Additionally, each component may perform their respective functionalities in response to a request from a human, or automatically without human intervention.

The application identification module 205 identifies a list of applications to track for ad share/spend determination. The list of applications are automatically identified based on various application data metrics such as apps ranking in an application store, or rates at which applications are downloaded to client devices (e.g., downloads per day). The applications may be further filtered by users, for example, users in a particular country where the received ads may be shown.

In one embodiment, the application identification module 205 downloads a web page with a top ranking chart of apps from a web site of an app store. Further the application identification module 205, parses the downloaded page to extract the available data for each app on the page. The application data is aggregated into a list. For each application on the list, a number of downloads within a time period (e.g., daily, weekly, monthly) is retrieved from a database. The list is filtered based on a predetermined number of downloads. The applications with a download above or equal to the predetermined number are selected as a list of applications to track.

An ad network SDK tracker 210 receives the list of identified applications. The ad network SDK tracker 210 inspects each application's code to search for binary signatures of known ad network SDKs. Advertising networks 104 provide an application developer embeddable SDKs that allow mobile applications to communicate with the advertising networks 104. The SDKs have unique sequences of executable code. The ad network SDK tracker 210 identifies these unique sequences (e.g. signatures or patterns), for example, by conducting a pattern search within the application code of each application. In one embodiment, the ad network SDK tracker 210 downloads a binary package of each application, from an application store, and unpacks the package. The ad network SDK tracker 210 searches for a signature for each ad network in each package. In other embodiments, a regular expression based on the signature pattern may be used to find a match within each ad network binary package.

In another embodiment, an application programming information (API) module may connect to an ad network. The API allows a client device 106 to log into the ad network (for example Facebook network) and allows the client device to extract ad information related to the client device 106 from the news feed data of the user of the client device 106

The key determination module 215 determines a key, i.e. a publisher-id and associated actual mobile application, for each application from the list of application that include known ad network SDKs. The publisher-id is a unique identity of a publisher in the ad network 104. A mobile application sends the publisher-id to the ad network 104 with each network request to serve an ad. To determine the key, an application environment is simulated to generate a network request to each ad network. For each ad network, a test application including the ad network's SDK is built. The test application is executed on a test device. The network traffic is monitored and analyzed to understand the ad network's protocol for requesting ads. The key determination module 215 emulates sending of the network requests, for each ad network 104, based on the understanding of each ad network's protocol.

An ad network 104 provides an application developer with a publisher-id that is used to send network requests for an ad from the ad network 104. For each application, the key determination module 215 receives the identified ad network SDK embedded within the application. The application is downloaded and the key determination module 215 searches for a publisher-id within the binary package of the downloaded application. The search is conducted based on the emulated network requests determined earlier by the key determination module 215 for each ad network SDK. Once a publisher-id is found from the binary package of the actual mobile application, the publisher-id and associated actual mobile application information is stored as a key in the key storage database 230.

The ad information determination module 220 tracks ad information for each application for each embedded ad network SDK to data related to an ad, such as the publisher of an ad, the number of applications an ad was displayed in, a date/time period of an ad impression, an ad creative, an ad platform, an ad network and other such information related to an ad. For each application, and for each embedded ad network SDK, the ad information determination module 220 retrieves a key from the key storage database 230. The ad information determination module 220 sends to the ad network 104 a network request using the publisher-id associated with the actual mobile application. The ad information determination module 220 may send multiple network requests to/for each network/publisher to get a stable view of an actual scenario. Further, the number of requests may be based on a user base size of a publisher.

The ad network 104 generates a response to the request and serves an ad to the ad information determination module 220. The response includes several ad related attributes, including a URL to an ad creative. An ad creative is an image or video displayed to a user of the client device 106. The ad information determination module 220 extracts information from the ad and stores it to a database.

The report generator 225 generates an ad information (ad share and/or spend) report. The ad share information may be within one or more mobile applications distributed over one or more ad networks 104. The reports are generally web based reports. A user may select the country, device, network, or time period. and may browse a set of ad creatives that were observed, within the selected information. The report may be further filtered by the creative format, or by the advertiser app, by the publisher app, or related metrics.

To compute the percentage share of an ad within a single application, all the ad impressions related to a single mobile application are retrieved from the database, and a percentage share is computed. For reports across more than one application (for example all applications), the ad share is weighted across all the applications, based on an application's usage across its user base, and the ad share is estimated based on the weighted ad share.

To compute ad spends, impressions and any other metric that is shown on the report, the computed ad share is combined with estimates of number of impressions shown to each user, along with average cost per install (CPI) and average cost per impression (CPM) information for the ad, determined by the advertisement analysis system. In one embodiment, to determine ad share and ad spend, the number of impressions assigned to a campaign is calculated from the ad responses stored in the database. Thus, in some embodiments, the relative amount of impressions for an advertisement campaign on a particular day on a particular advertisement network is presented against other advertisement campaigns of other advertisers on the same ad network. The CPI or CPM value for a campaign may be obtained from tracked usage data. Alternatively, CPI values may be estimated for particular ads and/or ad networks by a similarity function.

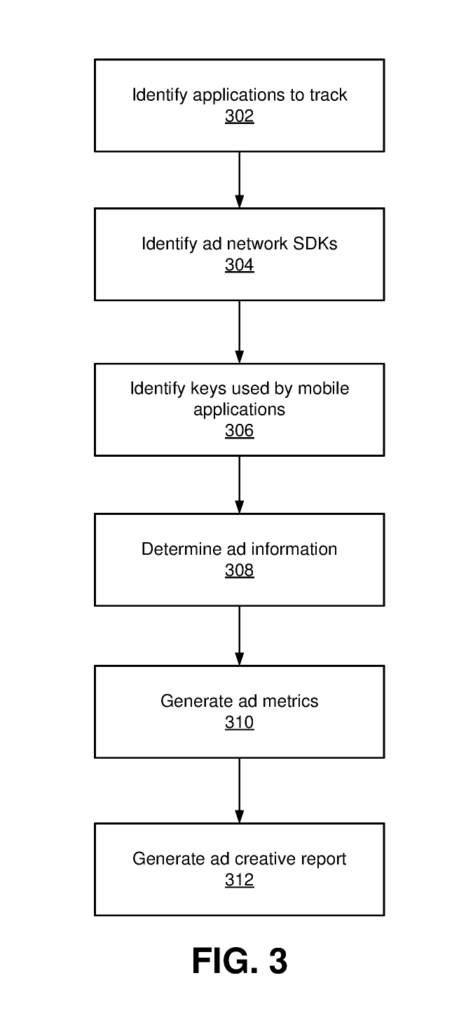

FIG. 3 is a flow diagram illustrating a method for generating an ad report according to one embodiment. Alternate embodiments may include more, fewer, or different steps from those illustrated in FIG. 3, and the steps may be performed in a different order from that illustrated in FIG. 3. Additionally, each of these steps may be performed automatically by the advertisement analysis system 108 without human intervention.

The advertisement analysis system 108 identifies 302 mobile applications installed on client devices. In one embodiment, the applications to track may be determined based on the popularity of a mobile application. For example, the mobile applications may be identified based on a rate at which the mobile applications are downloaded from an app store. For the identified applications, the advertisement analysis system 108 identifies 304 one or more ad network SDKs used by the identified mobile applications to communicate with the ad networks. To identify the one or more ad network SDKs, the advertisement analysis system 108 may analyze each application's code (e.g., source code, machine or assembly code, or binary code) detect a known ad network SDK.

Once the list of applications that include ad network SDKs are identified, the advertisement analysis system 108 identifies 306 a key for each mobile application. The key is a publisher-id associated with an actual mobile application. The publisher-id is used by an actual mobile application to send a request for an ad to an ad network. In some embodiments, the advertisement analysis system 108 extracts the publisher-id from code associated with a mobile application. The advertisement analysis system 108 simulates an environment that includes a test application that embeds code for each known SDK. The test application transmits a network request to each ad network to determine the network request protocol for each ad network. Based on the protocol, the test application determines a publisher-id pattern for each SDK. The advertisement analysis system 108 further searches each actual mobile application binary to find its publisher-id based on the determined publisher-id pattern and the determined SDK of the application. Once a publisher-id for the actual mobile application is found, the key (i.e. the publisher-id—mobile application information pair) is stored in the database.

Based on the keys for each application, for each ad network SDK, the advertisement analysis system 108 determines 308 ad information related to advertisements presented to users through the identified mobile applications using the ad networks. The ad information may be determined is by sending network requests to the ad networks using the publisher-id retrieved from the stored keys. The ad networks respond to the network requests with an ad and information that describes the ad.

The advertisement analysis system 108 generates 310 ad data metrics based on the determined ad information. The ad data metrics describe how the one or more advertisements are presented to users of the client devices. For example, the ad metrics may include an ad spend metric or an ad share metric. The ad share metric describes how often an advertisement is presented to a user in relation to other advertisements. The ad share metric may be determined based on the number of impressions associated with an advertisement in each mobile application. The ad spend metric represents an amount of money spent on advertising an advertisement using the ad networks. The ad spend metric may be determined based on the ad share metric an based on a cost per impression or a cost per installation associated with each mobile application.

The advertisement analysis system 108 generates 310 an ad creative report that describes the generated ad metrics. For example, the ad creative report may include the ad spend metric or the ad share metric. Additionally, the ad creative report may include ad creatives associated with advertisements displayed through the mobile applications using the ad networks, identifiers for publishers associated with the advertisements, or identifiers for mobile applications displaying the advertisements.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
identifying one or more mobile applications that are installed on a plurality of client devices;
identifying one or more ad network SDKs used by the one or more mobile applications to communicate with one or more ad networks;
identifying one or more keys associated with the one or more mobile applications installed on the plurality of client devices
determining, based on the identified one or more keys, ad information related to one or more advertisements presented to users of the plurality of client devices through the one or more mobile applications using the one or more ad networks;
generating one or more ad data metrics based on the determined ad information, the ad metrics describing how the one or more advertisements are presented to the users of the plurality of client devices; and
generating an ad creative report describing the one or more ad data metrics.

2. The method of claim 1, wherein the one or more mobile applications are identified based on a popularity of each of the one or mobile applications.

3. The method of claim 2, wherein the one or more mobile application are identified based on a rate of download from an app store of each of the one or more mobile applications.

4. The method of claim 1, wherein the ad network SDKs are identified by analyzing code associated with each of the one or more mobile applications.

5. The method of claim 1, wherein identifying the one or more keys comprises extracting one or more publisher identifiers from code associated with each of the one or more mobile applications.

6. The method of claim 1, wherein the ad information is determined by simulating each mobile application of the one or more mobile applications in a test environment.

7. The method of claim 6, further comprising: transmitting one or more network requests to the one or more ad networks using the simulated mobile applications, each network request comprising one of the one or more keys.

8. The method of claim 7, further comprising: receiving the one or more advertisements from the one or more ad networks in response to transmitting the one or more network requests.

9. The method of claim 7, further comprising: determining an ad network request protocol for each ad network of the one or more ad networks.

10. The method of claim 1, wherein the ad data metrics includes an ad spend metric.

11. The method of claim 10, wherein the ad spend metric is determined based on an ad share metric and estimates of costs per installation or costs per impression associated with the one or more mobile applications.

12. The method of claim 1, wherein the ad data metrics include an ad share metric.

13. The method of claim 12, wherein the ad share metric is determined based on numbers of impressions of each of the one or more advertisements in the one or more mobile applications.

14. The method of claim 1, wherein the ad creative report includes at least one of: a set of ad creatives corresponding to the one or more advertisements, an identifier for each of the one or more mobile applications, or identifiers for publishers of the one or more advertisements.

15. A non-transitory, computer-readable medium comprising instructions that, when executed by a processor, cause the processor to:
identify one or more mobile applications that are installed on a plurality of client devices;
identify one or more ad network SDKs used by the one or more mobile applications to communicate with one or more ad networks;
identify one or more keys associated with the one or more mobile applications installed on the plurality of client devices
determine, based on the identified one or more keys, ad information related to one or more advertisements presented to users of the plurality of client devices through the one or more mobile applications using the one or more ad networks;
generate one or more ad data metrics based on the determined ad information, the ad metrics describing how the one or more advertisements are presented to the users of the plurality of client devices; and
generate an ad creative report describing the one or more ad data metrics.

16. The computer-readable medium of claim 15, wherein the ad network SDKs are identified by analyzing code associated with each of the one or more mobile applications.

17. The computer-readable medium of claim 15, wherein the instructions for identifying the one or more keys comprise instructions that cause the processor to extract one or more publisher identifiers from code associated with each of the one or more mobile applications.

18. The computer-readable medium of claim 17, wherein the instructions further comprise instructions that cause the processor to: transmit one or more network requests to the one or more ad networks using the simulated mobile applications, each network request comprising one of the one or more keys.

19. The computer-readable medium of claim 15, wherein the ad data metrics includes an ad spend metric.

20. The computer-readable medium of claim 15, wherein the ad data metrics include an ad share metric.
